(19) United States
(12) Patent Application Publication
(10) Pub. No.: US 2008/0073898 A1
(43) Pub. Date: Mar. 27, 2008

(54) Inner pages strutcure for photo albums

(76) Inventor: Tao-Kuan Lee, Kaohsiung City (TW)

Correspondence Address: LEE, TAO-KUAN, P.O. Box 44-2049, Taipei, 10668, omitted

(21) Appl. No.: 11/525,849

(22) Filed: Sep. 25, 2006

(51) Int. Cl. B42D 1/00

(52) U.S. Cl. 281/15.1

(57) ABSTRACT

A photo album includes a plurality of overlapped inner pages and each inner page has a first paper board and a second paper board which is located beside the first paper board. A first film is attached on two respective first surfaces of the first and second paper boards, and a second film is attached on two respective second surfaces of the first and second paper boards. Two first tape pieces and two second tape pieces are connected on the first film and the second film. Photos are adhesive on the first tape pieces and the second tape pieces connect the adjacent inner pages so as to form a combination unit. A cover unit including a top cover and a bottom cover is connected to the combination unit.

### BACKGROUND OF THE INVENTION

(1) Field of the Invention

The present invention relates to structure of inner pages for a photo album and the inner pages securely position the photos thereon and the connection between the pages requires no punching and/or nailing processes.

(2) Description of the Prior Art

A conventional photo album 10 is shown in FIG. 1 and generally includes a plurality of inner pages 11 and each inner page 11 is composed of a first paper board 12 and a second paper board 13 which are glued with each other to form a thick inner page 11. Each of the first and second paper boards 12, 13 has at least one photo 14 glued thereon. A decoration member 20 encloses the periphery of the inner page 11 to further secure the first and second paper boards 12, 13. Multiple inner pages 11 are then connected with each other by gluing or nailing. A top cover 22 and a bottom cover are then connected to the stacked inner pages 11 and each top cover 22 and bottom cover is attached with a leather face 21.

The conventional photo album 10 requires multiple steps of gluing and that results in high manufacturing cost. The glue for gluing the photos 14 and the paper boards 12, 13 is affected by humidity and temperature so that air might be introduced between the photos 14 and the paper boards 12, 13 so that the photos 14 could be peeled off from the paper boards 12, 13.

The present invention intends to provide a photo album which includes multiple inner pages which are easily connected with each other without using the decoration member and the leather face.

### SUMMARY OF THE INVENTION

The present invention relates to a photo album that comprises multiple inner pages and each inner page has a first paper board and a second paper board which is located beside the first paper board. A first film is attached on two respective first surfaces of the first and second paper boards, and two first tape pieces are connected on the first film and located corresponding to the first and second paper boards. A second film is attached on two respective second surfaces of the first and second paper boards, and two second tape pieces are connected on the second film and located corresponding to the and second paper boards. Photos are attached on the first tape pieces and the first film. The first and second paper boards are overlapped with each other by overlapping respective first surfaces facing each other. A cover unit including a top cover and a bottom cover is connected to the combination unit.

The primary object of the present invention is to provide a photo album wherein the inner pages are connected with each other by using adhesive films and tape pieces.

Another object of the present invention is to provide a photo album wherein a gap is defined between the adjacent first and second paper boards so that the photos are not deformed when flipping the inner pages.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional photo album;

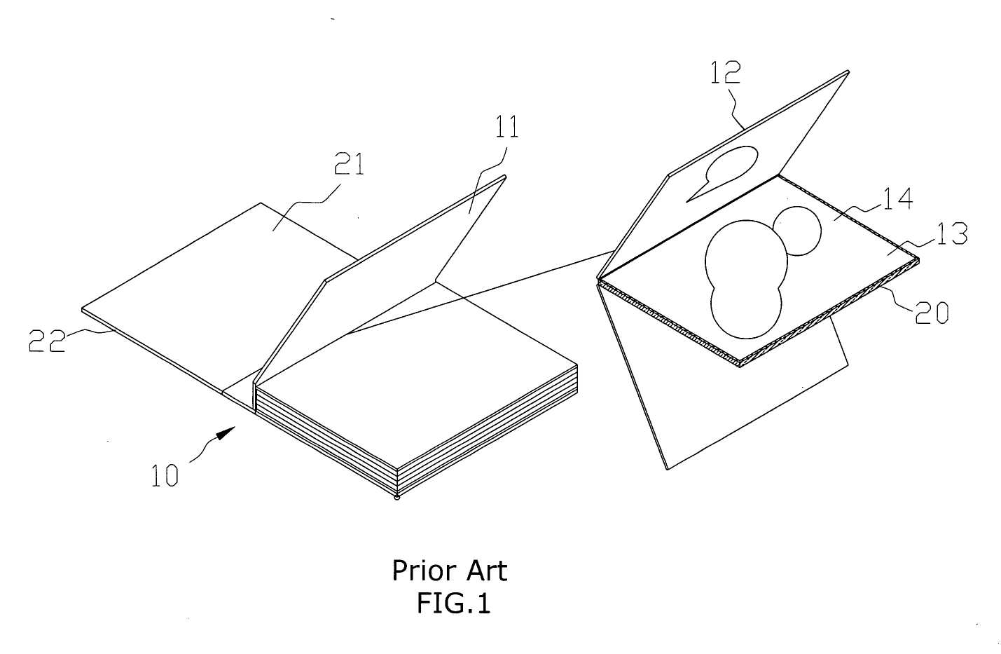

FIG. 2 is an exploded view to show the photo album of the present invention;

FIG. 3 shows that the inner pages of the photo album of the present invention are to be adhered with each other;

FIG. 4 shows the combination unit and the cover unit of the photo album of the present invention;

FIG. 5 shows a perspective view of the photo album of the present invention, and

FIG. 6 shows inner pages of the photo album of the present invention.

### DETAILED DESCRIPTION OF THE PREFERRED EMBODIMENTS

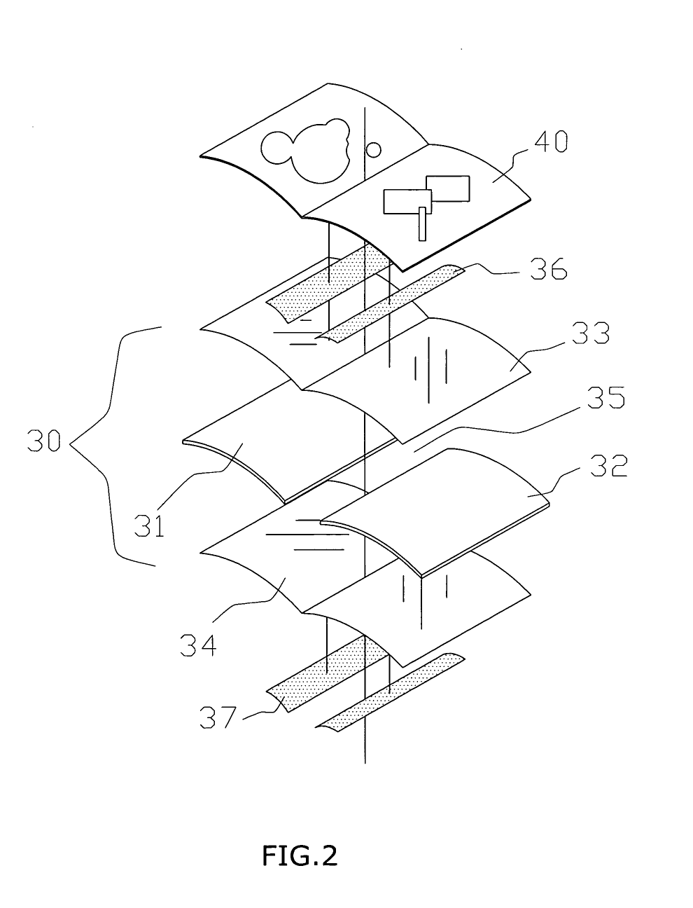

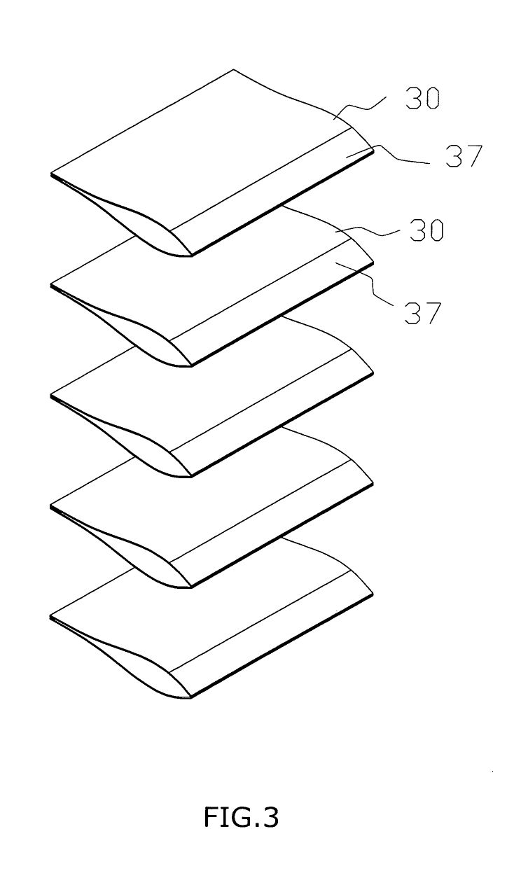

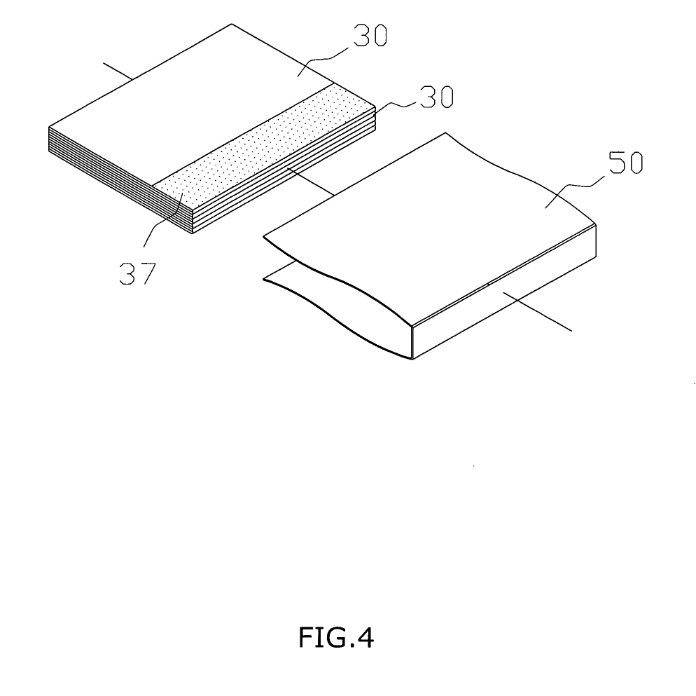

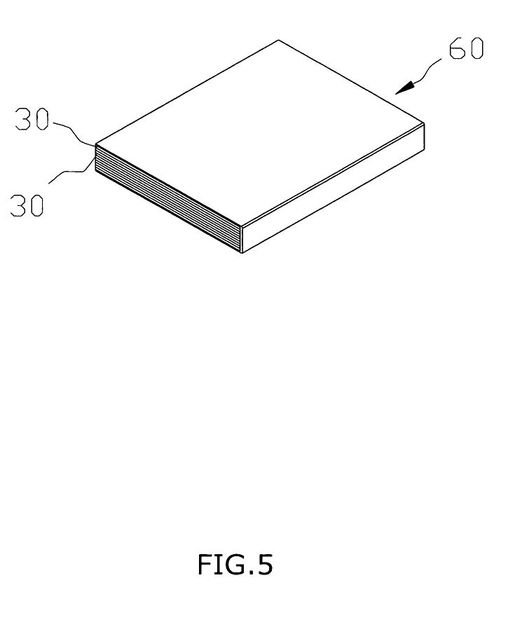

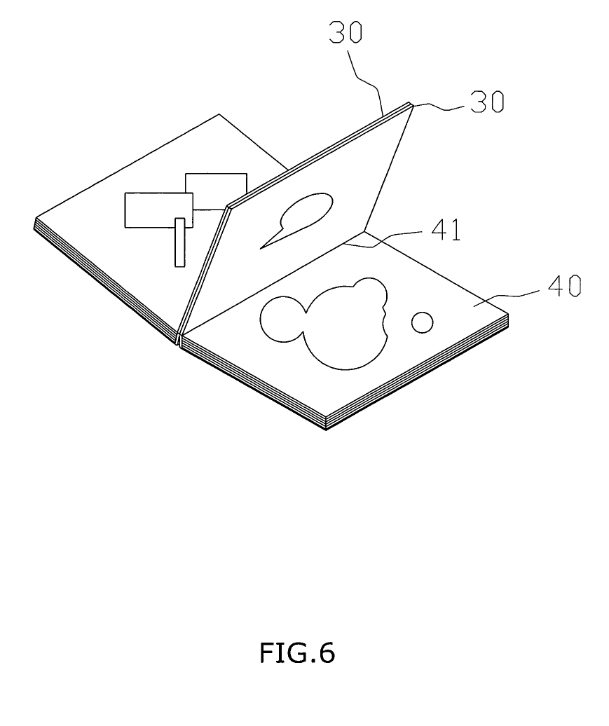

Referring to FIGS. 2 to 6, the photo album 60 of the present invention comprises a plurality of inner pages 30 which are stacked with each other to form a combination unit, and a cover unit 50. Each inner page 30 has a first paper board 31 and a second paper board 32 which is located beside the first paper board 31, and a gap 35 is defined between the first and second paper boards 31, 32 of each inner page 30. A first film 33 is attached on two respective first surfaces of the first and second paper boards 31, 32, and two first tape pieces 36 are connected on the first film 33 and located corresponding to the first and second paper boards 31, 32. A second film 34 is attached on two respective second surfaces of the first and second paper boards 31, 32, and two second tape pieces 37 are connected on the second film 34 and located corresponding to the first and second paper boards 31, 32. It is noted that the first and second films 33, 34 are adhesive after being heated, and the first and second tape pieces 36, 37 are two-sided tape strips. The inner pages 30 are overlapped and secured with each other by the second film 34 and second tap pieces 37 of each inner page 30.

Photos 40 are attached on the first tape pieces 36 and the first film 33. The first and second paper boards 31, 32 are overlapped with their respective first surfaces facing each other. The inner pages 30 are connected with each other by adhering two respective first surfaces facing each other so as to form the combination unit.

The cover unit 50 includes a top cover and a bottom cover. The cover unit 50 is connected to the overlapped inner pages 30 with the combination unit located between the top cover and the bottom cover. The top and bottom covers are adhered with the second tape pieces 37 of a top inner page 30 and a bottom inner page 30 of the combination unit. The cover unit 50 is connected with the combination unit by one step of heating and pressing.

Due to the gap 35 between the first and second paper boards 31, 32 of each inner page 30, when flipping the inner pages 30, the folding line 41 of each inner page 30 will not affect the photos 40. The connection of the combination unit and the cover unit 50 of the photo album 60 needs only one step of heating and pressing, so that the photo album 60 is easily to assembled and use less glue.

While we have shown and described the embodiment in accordance with the present invention, it should be clear to those skilled in the art that further embodiments may be made without departing from the scope of the present invention.

What is claimed is:

1. A photo album comprising:
a plurality of inner pages and each inner page having a first paper board and a second paper board which is located beside the first paper board, a first film attached on two respective first surfaces of the first and second paper boards, two first tape pieces connected on the first film and located corresponding to the first and second paper boards, a second film attached on two respective second surfaces of the first and second paper boards, two second tape pieces connected on the second film and located corresponding to the and second paper boards, photos attached on the first tape pieces and the first film, the first and second paper boards being overlapped with their respective first surfaces facing each other, the inner pages being connected with each other by adhering two respective first surfaces facing each other so as to form a combination unit, and
a cover unit including a top cover and a bottom cover, the combination unit being located between the top cover and the bottom cover of the cover unit.

2. The photo album as claimed in claim 1, wherein a gap is defined between the first and second paper boards of each inner page.

3. The photo album as claimed in claim 1, wherein the first and second tape pieces are two-sided tape strips.

4. The photo album as claimed in claim 1, wherein the first and second films are adhesive films.

5. The photo album as claimed in claim 1, wherein the inner pages are overlapped and secured with each other by the second film of each inner page.

6. The photo album as claimed in claim 1, wherein the first and second films are adhesive after being heated.
